(19) United States
(12) Patent Application Publication
(10) Pub. No.: US 2006/0152329 A1
(43) Pub. Date: Jul. 13, 2006

(54) Conductive polymer device and method of manufacturing same

(76) Inventor: Sten Bjorsell, Macroom (IE)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/146,890

(22) Filed: Jun. 6, 2005

Related U.S. Application Data
(63) Continuation-in-part of application No. PCT/US03/07875, filed on Mar. 14, 2003.
(60) Provisional application No. 60/432,493, filed on Dec. 11, 2002.

(51) Int. Cl. H01C 7/13

(52) U.S. Cl. 338/22 R

(57) ABSTRACT

An electronic device is manufactured using printed circuit board manufacturing processes. In particular, a laminar device comprises a first metal layer (12), a second metal layer (14), at least one layer of device material sandwiched between the first and second metal layers. A first layer of insulating material (40) substantially covers the first metal layer (12). A third metal layer (48) is provided on the first layer of insulating material (40). This third metal layer (48) is divided to provide a first terminal (90) and a second terminal (92). The first terminal (90) is electrically connected to the first metal layer (12) by a conductive interconnect (84) formed through said first layer of insulating material (40), and the second terminal (92) is electrically connected to said second metal layer (14) by a conductive path (68) comprising an insulated conductive channel which passes through and is insulated from said first metal layer (12) and said at least one layer of device material (16). The use of an insulated channel provides a cost effective method of manufacture and maximizes the effective area of device material used. A PTC component is built through this method.

### CROSS-REFERENCES TO RELATED APPLICATIONS

This application is related to PCT/US2003/007875 (WO2004/053899), which claims the benefit of U.S. Provisional Application No. 60/432,493, filed on Dec. 11, 2002. This application is also related to U.S. patent application Ser. No. ______ (Attorney docket no. 025959-000100US), which is being filed on the same day as the present application. All of the above applications are herein incorporated by reference in their entirety for all purposes.

### BACKGROUND OF THE INVENTION

The present invention relates generally to the field of electronic devices. More specifically, this invention relates to positive temperature coefficient (PTC) devices that are designed for overcurrent protection and can be surface mounted in printed circuit board (PCB) applications.

It is well known that the resistivity of many conductive materials changes with temperature. For example, the resistivity of a PTC material increases as the temperature of the material increases. Examples of such a material are organic polymers, made electrically conductive by dispersing conductive fillers therein. These polymers generally include polyolefins such as polyethylene, polypropylene and ethylene/propylene copolymers. Conductive fillers include carbon black and metal powders.

Typically, a conductive polymer PTC device comprises a layer of conductive polymer PTC material sandwiched between upper and lower metal foil electrodes. The prior art includes single layer devices and multilayer devices, the latter comprising two or more conductive polymer layers separated by one or more internal metal foil electrodes, with external metal foil electrodes on the upper and lower surfaces. Examples of such devices and their methods of manufacture are disclosed in the following U.S. patents, the disclosures of which are incorporated herein by reference: U.S. Pat. No. 6,429,533; U.S. Pat. No. 6,380,839; U.S. Pat. No. 6,377,467, U.S. Pat. No. 6,242,997; U.S. Pat. No. 6,236,302; U.S. Pat. No. 6,223,423; U.S. Pat. No. 6,172,591; U.S. Pat. No. 6,124,781; U.S. Pat. No. 6,020,808; and U.S. Pat. No. 5,802,709.

At temperatures below a certain value, referred to generally as the critical or switching temperature, PTC materials of the type referred to above exhibit a relatively low, constant resistivity. However, as the temperature of the PTC material increases beyond the critical temperature, the resistivity of the material sharply increases with temperature. When the temperature of the material cools down below the critical or switching temperature, the resistivity reverts to its low, constant value. This effect has been used in the production of electronic PTC devices providing overcurrent protection in electrical circuits, where they are generally placed in series with a load.

There is an on-going trend in the electronics industry toward miniaturization, and in particular reduction of the physical size of the components. One way this has been achieved is the introduction of surface mount technology (SMT) components. In SMT components, the devices are soldered directly to the circuit boards, thus doing away with the space requirement for leads on devices and corresponding holes in the circuit boards. Still, as with other electronic applications, in SMT there is an on-going need to minimize the effective surface area or footprint of the devices. However, the operational requirements of PTC devices limit the degree to which the operational surface area of the PTC material can be reduced.

This need for an effective surface area based on the operational requirements of the devices is a major limiting factor in the design of small SMT PTC devices. For example, to maximize the effective surface area for a given footprint, the two electrical terminals for a PTC device may be positioned at opposing ends of the device. While this facilitates the full use of the surface area of the PTC material, the requisite soldering process occupies valuable space on a printed circuit board (PCB), effectively increasing the footprint of the PTC device.

A known solution to this problem is to position the two electrical terminals on the underside of the PTC device. This, however, requires that a connection be provided from the upper foil electrode layer of the PTC device to a terminal on the underside. This connection either significantly reduces the effective area of the PTC material or requires the use of a wrap around connection, which adds cost. For example, in U.S. Pat. No. 6,292,088 a PTC device is disclosed in which an interconnection passes through the device. To prevent the interconnection shorting the two metal layers, a section of one of the metal layers adjacent to the interconnection is removed to provide an isolation barrier. However, the removal of this section significantly reduces the effective surface area of the PTC device, as the area of the metal layer removed to provide isolation equates approximately to the thickness of the PTC material. In addition, the area of metal that has been isolated, and the corresponding region of PTC material, serves no other purpose than to provide an electrical contact. U.S. Pat. No. 6,377,467 discloses a PTC device having a pair of terminals on the underside of device. The terminals are positioned on-top of an insulating layer to isolate them from each other and also from underlying electrodes of the PTC material. Each of the terminals of the pair are connected to a corresponding terminal on the top side of the device by an interconnection. The interconnections also provide electrical connections to the electrodes of the PTC material. However, to prevent the interconnections shorting the two electrodes, a section of one of the metal electrodes adjacent to each interconnection is removed to provide an isolation barrier. Thus the effective area of the PTC device is significantly reduced.

U.S. Pat. Nos. 5,907,272 and 5,884,391 show examples of PTC devices in which the connection from the upper foil layer to a terminal on the underside is provided by a wrap-around conductor arrangement. This configuration makes an electrical connection by wrapping a conductive layer around the PTC material rather than wasting surface area of the PTC material in providing an interconnection. It is suggested however that the manufacturing methods of these patents may be inefficient and costly.

Accordingly, there is a need for an improved SMT PTC device, and a method for manufacturing it, in which the usable effective surface area of the PTC material within a given footprint on a PC board is maximized, and in which connections required to connect the upper electrode to the lower electrode use optimum area and at the same time do not reduce the effective area of the PTC material.

### BRIEF SUMMARY OF THE INVENTION

In one aspect, the present invention provides a method of manufacturing an electronic device from a structure comprising at least one layer of device material sandwiched between a first layer of metal and a second layer of metal. The method comprises the steps of forming a first aperture through the first layer of metal, the second layer of metal and the device material; applying a first layer of insulating material to the first metal layer, insulating the walls of the first aperture, providing a third metal layer on the first layer of insulating material, forming a second aperture within the region defined by the first aperture, providing a first electrical interconnection between the top and bottom surfaces of the through the second aperture, creating an electrical interconnection between the third metal layer and the first metal layer, selectively removing metal from the third metal layer to define first and second electrode areas, wherein the first terminal includes the electrical interconnection created between the third metal layer and the first metal layer and the second terminal includes the plated second aperture.

By using an insulated conductive channel to provide a path from one side of the device to the other, the effective surface area of the active material may be maximized, since only the area occupied by the channel is required to provide the interconnection between the upper and lower surfaces of the device.

The method may comprise the further steps of applying a second layer of insulating material on the second metal layer, and providing a fourth metal layer on the second layer of insulating material in advance of forming the second aperture.

The step of insulating the walls of the first aperture may be performed at least in part by the step of applying the first layer of insulating material to the first metal layer and/or by the step of applying the second layer of insulating material to the first metal layer,

In advance of the application of the insulating layers, a third aperture may be formed through the first metal layer, second metal layer and the at least one layer of device material subsequent to which a fourth aperture may be formed within the region defined by the third aperture. Whereupon the fourth aperture may be plated to provide a second electrical interconnection between the top and bottom surfaces of the device.

Third and fourth terminals may be defined using an additional step of selectively removing material from the fourth metal layer.

The first and third apertures may be formed at opposing ends of the device.

The method may include the initial step of defining singulation references in the first and second layers of metal.

Advantageously, the steps of applying the first layer of insulating material to the first metal layer and providing a third metal layer on the first layer of insulating material may be performed in a single step by the application of a resin clad metal, optionally copper.

Similarly, the steps of applying the second layer of insulating material to the second metal layer and providing the fourth metal layer on the second layer of insulating material may be performed in a single step by the application of a resin clad metal, optionally copper.

Optionally, the structure comprising at least one layer of device material sandwiched between a first layer of metal and a second layer of metal maybe a multi layer structure comprising alternating layers of device material and metal.

The method of manufacturing a device is particularly suitable for the manufacture of PTC devices, and in which case the device material is a PTC material.

The structure comprising at least one layer of device material sandwiched between a first layer of metal and a second layer of metal may be provided as a laminated sheet.

In another aspect of the invention, an electronic-device-is provided comprising a first metal layer, a second metal layer and at least one layer of device material sandwiched between the first metal layer and the second metal layer which function as electrodes for the device material. A first terminal is provided for a first electrical connection to the device and a second terminal is provided for a second electrical connection to the device, wherein the first terminal is electrically connected to the first metal layer and the second terminal is insulated from the first metal layer and electrically connected to the second metal layer by a conductive channel which passes through and is insulated from the first metal layer and device material. The conductive channel may be a metal plated channel.

The second terminal may be insulated from the first metal layer by a first layer of insulating material. This first layer of insulating material may substantially cover the first layer of metal.

A third layer of metal may be provided on the first layer of insulating material. This third layer may be divided by an isolation area to provide the first terminal and the second terminal.

The device may further comprise a third terminal for providing a third electrical connection to the device and a fourth terminal for providing a fourth electrical connection to the device, wherein the fourth terminal is electrically connected to the second metal layer and the third terminal is insulated from the second metal layer and electrically connected to the first metal layer by a second conductive channel which passes through and is insulated from the second metal layer and device material.

The second conductive channel may be a metal plated channel, which may be located at one end of the device. Moreover, the first conductive channel and the second conductive channel may be located at opposing ends of the device.

The second terminal may be insulated from the second metal layer by a second layer of insulating material, which may substantially cover the second layer of metal.

The fourth terminal may be electrically connected to the second metal layer by an interconnect formed through said second layer of insulating material.

The terminals of the device may be plated, optionally with nickel, copper and/or gold. The insulating material may comprise a cured resin. The at least one layer of device material may comprise alternating layers of device material and metal.

The device may be a PTC device and in which case the device material is a PTC material.

In another aspect-of the invention a PTC device is provided comprising: a first metal layer, a second metal layer and at least one layer of PTC material sandwiched between the first metal layer and the second metal layer. A first terminal is provided as a first electrical connection to the device and a second terminal is provided as a second electrical connection to the device, wherein the first terminal is electrically connected to the first metal layer and the second terminal is electrically connected to the second metal layer by a conductive channel which passes through and is insulated from the first metal layer and the at least one layer of PTC material.

In a further aspect of the invention, a method of manufacturing a matrix of electronic devices from a structure comprising at least one layer of device material sandwiched between a first layer of metal and a second layer of metal is provided. The method comprising the steps of forming a first array of apertures through the first layer of metal, the second layer of metal and the device material, applying a first layer of insulating material to the first metal layer, insulating the walls of the first array of apertures, providing a third metal layer on the first layer of insulating material, forming a second array of apertures such that each aperture of the second array is positioned within the region defined by an aperture from the first array of apertures, providing electrical interconnections between the top and bottom surfaces of the matrix through the second array of apertures to create electrical interconnections between the third metal layer and the first metal layer, selectively removing metal from the third metal layer to define first and second terminals for each device of the matrix, wherein each first terminal includes an electrical interconnection between the third metal layer and the first metal layer and each second terminal includes an insulated electrical interconnection between the top and bottom surfaces of the device.

The step of insulating the walls of the first array of apertures may be performed at least in part by the step of applying the first layer of insulating material to the first metal layer,

The method may comprise the further steps of applying a second layer of insulating material on the second metal layer, and providing a fourth metal layer on the second layer of insulating material in advance of forming the second array of apertures.

Advantageously, the step of insulating the walls of the first array of apertures may be performed at least in part by the step of applying the second layer of insulating material to the first metal layer.

The method may comprise the further steps of forming a third array of apertures, in advance of the application of the insulating layers, through the first metal layer, second metal layer and the at least one layer of device material, forming a fourth array of apertures within the region defined by the third array of apertures, and providing electrical interconnections between the top and bottom surfaces of the device through the fourth array of apertures.

The method may comprise the additional step of selectively removing material from the fourth metal layer to define third and fourth terminals for individual devices in the matrix.

Each of the first array of apertures and each corresponding aperture of the third array of apertures may be formed on opposing ends of the individual devices within the matrix.

As an initial step singulation references may be defined in the first and second layers of metal.

Advantageously, the steps of applying a first layer of insulating material to the first metal layer and providing a third metal layer on the first layer of insulating material may be performed in a single step by the application of a resin clad metal, optionally copper.

Similarly, the steps of applying a second layer of insulating material to the second metal layer and providing a fourth metal layer on the second layer of insulating material may be performed in a single step by the application of a resin clad metal, optionally copper.

Optionally, the structure comprising at least one layer of device material sandwiched between a first layer of metal and a second layer of metal may be a multi layer structure comprising alternating layers of device material and layers of metal.

Where the device is a PTC device, the device material is a PTC material.

The method may comprise the additional step of joining a second matching matrix of electronic devices to the matrix such that terminals of adjoining faces of each matrix are aligned and electrically connected. As a final step, the devices may be singulated from the matrix.

As part of the singulation process, groups of two or more devices may be singulated together as individual devices. In this case, they may be configured as SIP or DIP packages.

The device material may be a dielectric material.

In a further aspect of the invention, a matrix of electronic devices is provided comprising a first metal layer, a second metal layer and at least one layer of device material sandwiched between the first metal layer and the second metal layer which function as electrodes for the device material. First and second arrays of terminals provide electrical connections to individual devices of the matrix, wherein the first array of terminals are electrically connected to the first metal layer and the second array of terminals are insulated from the first metal layer and electrically connected to the second metal layer by conductive channels which pass through and are insulated from the first metal layer and device material. The conductive channels may be metal plated channels. The second array of terminals may be insulated from the first metal layer by a first layer of insulating material, which may substantially cover the first layer of metal.

A third layer of metal may be disposed on the first layer of insulating material, here said third layer is divided by an array of isolation areas to provide the first array of terminals and the second array of terminals.

Third and fourth arrays of terminals may also provide electrical connections to individual devices. Moreover, the fourth array of terminals may be electrically connected to the second metal layer, and the third array of terminals may be insulated from the second metal layer and electrically connected to the first metal layer by a second array of conductive channels which pass through and are insulated from the second metal layer and material.

The second array of conductive channels may comprise metal plated channels. The second array of terminals may be insulated from the second metal layer by a second layer of insulating material which may substantially cover the second layer of metal.

The fourth array of terminals are electrically connected to the second metal layer by interconnects formed from through said second layer of insulating material.

Each of the array of second conductive channels is provided at an end of each device of the matrix moreover each of the array of first conductive channels and second conductive channels may located at opposing ends of each device of the matrix.

The terminals of the matrix may be plated, optionally with nickel, copper and/or gold.

The insulating material may comprise a cured resin.

The at least one layer of device material may comprise alternating layers of device material and layers of metal. Where the devices of the matrix are PTC devices the device material is a PTC material.

The invention extends to a stacked matrix comprising at least two matrices of the type described which are stacked on top of each other and in which corresponding terminals are electrically connected.

The above mentioned advantages of the present invention, as well as others, will be more readily appreciated from the detailed description that follows.

### BRIEF DESCRIPTION OF THE DRAWINGS

The invention will now be described with reference to the drawings in which:

FIG. 1 is a cross-sectional view of a portion of a laminated sheet from which the present invention is made;

FIG. 2 is a top plan view of the sheet portion shown in FIG. 1, after the step of forming a first array of apertures in the sheet;

FIG. 3 is a cross-sectional view taken along line X-X of FIG. 2;

FIG. 4 is a cross-sectional view, similar to that of FIG. 3, showing the result of a subsequent step in the process of the invention;

FIG. 5 is a cross-sectional view, similar to that of FIG. 4, showing the result of the next step in the process of the invention;

FIG. 6 is a cross-sectional view, similar to that of FIG. 5, showing the result of the next step in the process of the invention;

FIG. 7 is a cross-sectional view, similar to that of FIG. 6, showing the result of the next step in the process of the invention;

FIG. 8 is a cross-sectional view, similar to that of FIG. 7, showing the result of the next step in the process of the invention;

FIG. 9 is a cross-sectional view, similar to that of FIG. 8, showing a finished symmetrical PTC device according to the invention;

FIG. 10 is a cross-sectional view of a non-symmetrical embodiment of the PTC device of the invention;

FIG. 11 is a cross-sectional view of a multi-layer PTC device according to the invention;

FIG. 12 is a top view of an embodiment of the invention comprising four individual PTC devices packaged as a single multi-device component;

FIG. 13 is a top view of a SIP embodiment of the invention comprising an individual device;

FIG. 14 is a schematic representation of a line protection circuit suitable for implementation by devices of the invention;

FIG. 15 is a top view of an implementation of the schematic circuit of FIG. 14 according to the invention;

FIG. 16 is a side view of a matrix of devices;

FIG. 17 is a side view of the matrix of FIG. 16, illustrating a further step in a process of the invention;

FIG. 18 is a side view of the matrix of FIG. 17, illustrating a further step in a process of the invention; and

FIG. 19 is a side view of a singulated device formed from the matrix of FIG. 18.

FIGS. 20(a) and 20(b) are cross-sectional side and plan views respectively of a component being produced; and

FIGS. 21, 22, and 23 are side views showing method steps in more detail.

### DETAILED DESCRIPTION OF THE INVENTION

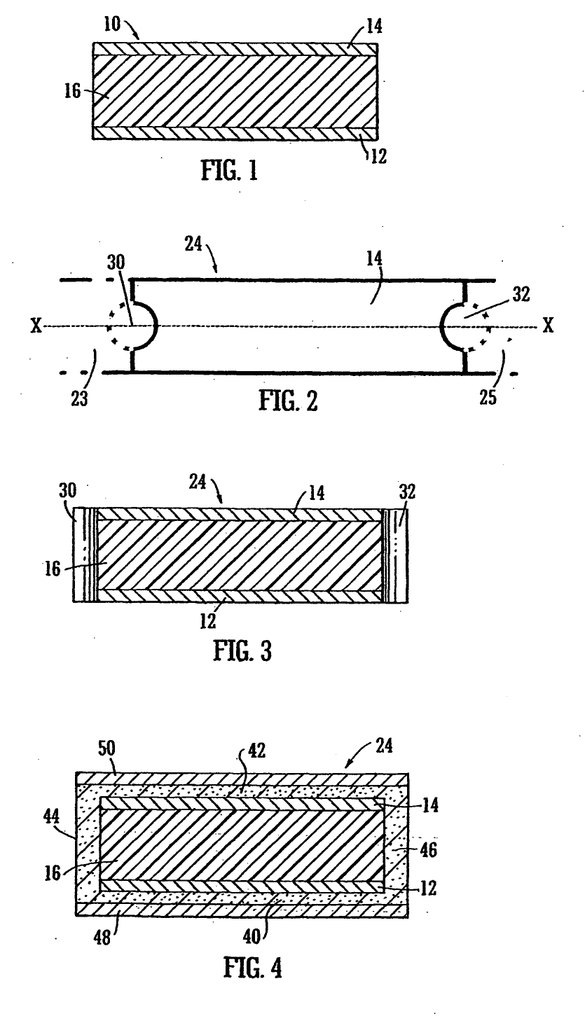

Referring now to the drawings, FIG. 1 illustrates a portion of a laminated sheet 10 that may be provided as an initial step in the process of manufacturing an electronic device in accordance with the present invention. The sheet 10 comprises two layers of metal foil 12, 14 and a region of active device material, for example conductive polymer PTC material 16. Specifically, the exemplary laminated sheet 10 shown comprises a layer of conductive polymer PTC material 16 sandwiched between a first or lower layer of metal foil 12 and a second or upper layer of metal foil 14.

The layer of conductive polymer PTC material 16 may comprise any suitable PTC material, including for example any suitable conductive polymer composition. An example of a suitable conductive polymer composition would be high density polyethylene (HDPE) into which is mixed an amount of carbon black that results in the desired electrical operating characteristics. An example of such a mixture is disclosed in WO97/06660, the disclosure of which is incorporated herein by reference. The metal layers 12, 14 may comprise any suitable metal, typically provided as a thin foil, with copper being preferred, although other metals, such as nickel and aluminum along with a number of alloys are also acceptable.

The laminated sheet 10 may be formed by any of several suitable processes that are well known in the art, as exemplified by the above referenced publication WO97/06660.

The present invention, in one aspect, is a manufacturing method or process comprising a series of processing steps performed upon the laminated sheet 10 to produce a matrix comprising a plurality of electronic devices. These steps will now be explained with reference to FIGS. 2 through 13.

An advantageous first step in the exemplary process is the definition, in the sheet 10, of an array of singulation lines (not shown), that define a matrix of sheet sections 23, 24, 25 (FIG. 2), each of which will be formed into an individual device, as described below. The fully formed individual devices will, at the end of the process described below, be singulated from the matrix along the singulation lines. The singulation lines may comprise a rectangular (X-Y) grid of lines formed by the selective removal of metal from the first layer 12 and/or second layer 14 of metal. The selective removal of this metal may be by any suitable process including standard printed circuit board assembly techniques employing photo-resist and etching methods well known in the art.

After the formation of the singulation lines, the next step in the process, illustrated in FIG. 2, is the formation of a first array of apertures 30, 32 in the laminated sheet 10. Each section 24 of the sheet to be singulated should have at least one aperture or share an aperture with an adjoining section. Any suitable PCB process including drilling, laser drilling, etching and punching may form the apertures 30, 32. The apertures provide openings from the top surface (upper metal layer 14) of the laminated sheet through to the lower surface (lower metal layer 12) of the laminated sheet.

The remaining steps of the process will be described with reference to this single section 24 defining an individual unit or device. It will be appreciated, however, that the subsequent process steps are intended to produce a matrix of devices from the laminated sheet 10 as a whole, and that the individual unit is only shown for clarity. In practice the individual unit is not singulated from the matrix until substantially all of the process steps have been completed.

As illustrated in FIG. 3, each of the apertures 30, 32 passes through the first metal layer 12, the layer of PTC material 16 and the second metal layer 14; i.e., the apertures 30, 32 define channels from the bottom surface of the laminated sheet 10 to the top surface. As illustrated in FIG. 4, after the apertures 30, 32 have been formed, a first layer of insulating material 40 is formed on or applied to the surface of the first layer 12 of metal. Similarly, a second layer of insulating material 42 is formed on or applied to the surface of the second layer 14 of metal. The insulating material is selected to ensure that it will flow into and substantially fill the apertures 30, 32, either directly or under pressure. These steps ensure that regions 44, 46 of insulating material substantially fill the apertures 30, 32. Although it is preferable that the apertures 30, 32 are replaced/filled by regions of insulating material, the primary purpose of the insulating material is to provide an insulating barrier to the walls defining the apertures 30, 32, i.e. the exposed edge surfaces of the first metal layer 12, the PTC material 16, and the second metal layer 14 defining the apertures. It will also be appreciated that a separate process may be used to provide an insulating barrier to the walls of the apertures distinct from the application of the first and second layers of insulation, i.e. using a separate process to fill the apertures 30, 32 with insulating material. However, this is a less preferred alternative as it introduces an additional step to the process.

The insulating material may be any suitable material, including plastic (e.g. epoxy resin). Fibers (e.g. glass) may be included within the insulating material to provide mechanical strength. In particular, the material referred to generally in the PCB industry as pre-preg, is an ideal insulating material. A preferred specific type of pre-preg for this application comprises a 1080 glass fabric (fiber glass) filled with a 62% resin content.

A third metal layer 48 is formed on or applied to the first layer of insulating material 40. Similarly, a fourth metal layer 50 is formed on or applied to the second layer of insulating material 42, resulting in the structure shown in FIG. 4. Suitable materials for the metal layers 48, 50 may include foils of copper, nickel, aluminum, and a number of alloys thereof. Such foils may be laminated or bonded to the respective insulating layers 40, 42. Deposition processes such as plating may also provide the third and fourth metal layers.

Advantageously, the steps of applying the layers of insulating material and metal may be combined into a single step through the use of resin clad metal materials, for example resin clad copper (RCC). The use of RCC allows the metal and insulating layers to be applied concurrently. A suitable RCC material would be a 1080 glass fabric impregnated with a 62% resin content and clad with copper. The adherence of the first and second insulating layers 40, 42 to the first and second metal layers 12, 14 respectively may be achieved by conventional PCB techniques, familiar to those skilled in the art.

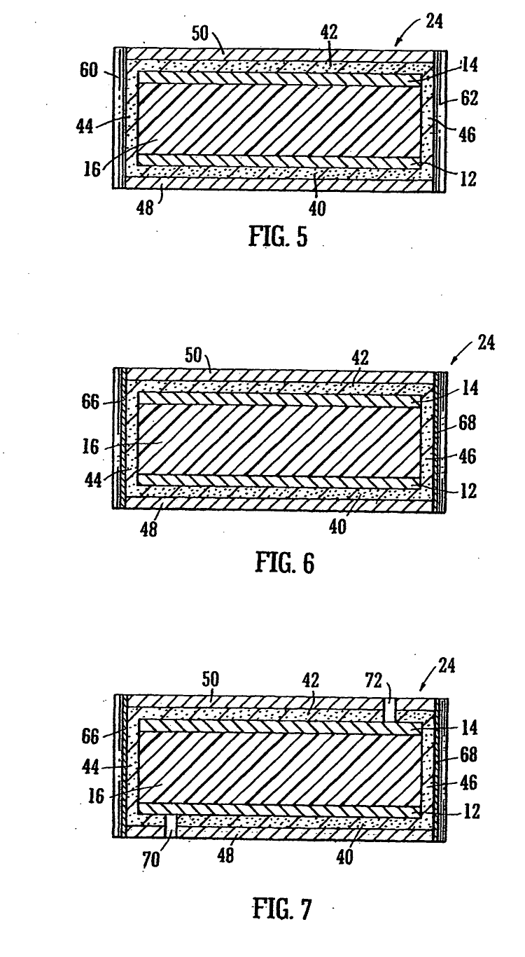

After the insulating layers 40, 42 and additional metal layers 48, 50 have been applied/formed, a second array of apertures 60, 62 is defined/formed in the laminated sheet 10. Any suitable process including conventional drilling or laser drilling techniques may form these apertures. Each aperture 60, 62 of this second array is suitably formed within the boundary defined by a corresponding aperture 30, 32 of the first array of apertures, as illustrated in FIG. 5. The diameter of each of the apertures 60, 62 of the second array of apertures is less than the diameter of the apertures 30, 32 of the first array of apertures. The result of using smaller diameter apertures for the second array is that each of the apertures 60, 62of the second array provides an insulated channel between the upper and lower surfaces of the laminated sheet 10 which is insulated from the first and second layers of metal 12, 14 and the layer PTC material 16. The insulating barrier 44, 46 for the channels is provided by the insulating material from the first and second layers of insulating material which substantially filled the first array of apertures 30, 32.

The next step in the process, illustrated in FIG. 6, is to provide conductive paths between the third 48 and fourth 50 metal layers using each of the insulated channels provided by the apertures 60, 62 in the second array. That is, an array of external electrical interconnections 66, 68 is formed between the top and bottom surfaces of the sheet 10. These interconnections may be provided by any suitable process, including for example, plating (i.e. provision of a plated through-hole via) or the insertion of a conductive material. Examples of suitable conductive materials may include conductive epoxy or solder paste. A suitable plating process is an electroplating process. Suitably, in an electro-plating process, the third metal layer 48 is used as a first electrode and the fourth metal layer 50 is used as a second electrode for the plating process. The result, as shown in FIG. 6, is the provision of a pair of external conductive interconnections 66, 68 between the top and bottom surfaces of the laminated sheet 10 on opposite ends of each unit or section 24.

After forming the external conductive interconnections 66, 68, a first array of internal interconnections is formed between the fourth metal layer 50 and the second metal layer 14. Similarly, a second array of internal interconnections is provided between the third metal layer 48 and the first metal layer 12. These internal interconnections will provide conductive paths between the first metal layer 12 and the third metal layer 48, and between the second metal layer 14 and the fourth metal layer 50. As shown in FIG. 7, before an electrical connection between the first and third metal layers may be provided, a first array of openings or “micro-vias” 70 is formed from the lower surface of the sheet (the third metal layer 48) through to the surface of the first metal layer 12, while a second array of blind openings or “micro-vias” 72 is formed from the upper surface of the of the sheet (the fourth metal layer 50) through to the surface of the second metal layer 14. Suitable methods for forming these blind openings or micro-vias 70, 72 include laser drilling and etching.

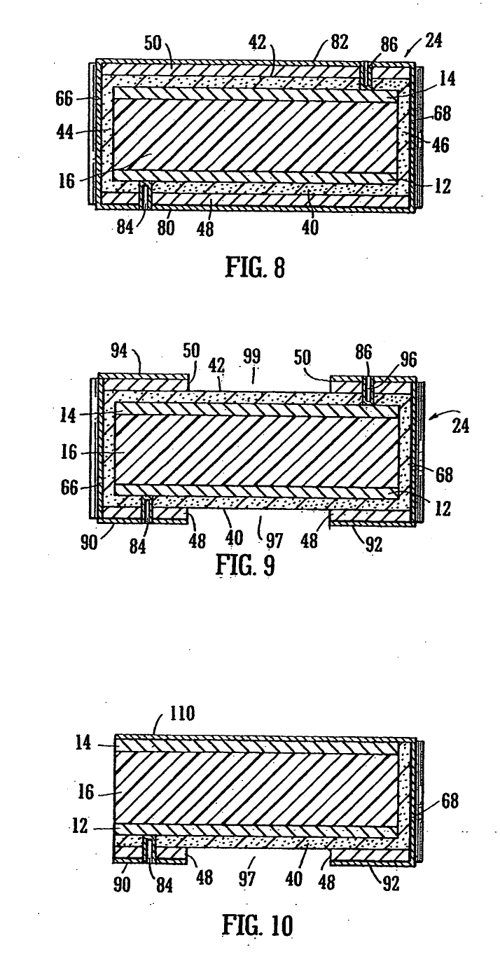

Once the micro-vias 70, 72 have been formed, the internal electrical interconnections may be established through the micro-vias by disposing conductive material within them. The preferred method of providing the conductive material is a conventional plating process, such as electroplating or electroless plating. The electrical connections may also be provided by inserting a conductive material, for example conductive epoxy or solder paste, into the microvias 70, 72. Assuming a suitable plating process is used, FIG. 8 shows a lower plating layer 80 and an upper plating layer 82 deposited over the third and fourth metal layers 48, 50 respectively. The plating layers 80, 82 fill the micro-vias 70, 72, respectively, forming lower and upper internal conductive interconnections 84, 86, respectively, within the micro-vias 70, 72. As a result of this plating, a continuous path of conductive metal is formed from the first metal layer 12, through the lower internal interconnection 84, the lower plating layer 80, the first external interconnection 66, the upper plating layer 82, and the second external interconnection 68. A conductive path is also established between the second metal layer 14 to the upper plating layer 82 through the upper internal interconnection 86, as shown in FIG. 8.

At this point it is necessary to form two separate, electrically isolated conductive paths so as to provide a first terminal that electrically connects the first metal layer 12 to the upper plating layer 82, and a second terminal, electrically isolated from the first terminal, that electrically connects the second metal layer 14 to the lower plating layer 12. The formation of the first and second terminals for subsequent use as connection points for the PTC devices is shown in FIG. 9. The lower plating layer 80 and the third metal layer 48 are masked and selectively etched away to form lower isolation areas 97 on the lower surface of the sheet 10 that are devoid of metal and that divide the third metal layer 48 and the lower plating layer 80 of each unit 24 into separate first and second lower terminal pads 90, 92 (i.e. the areas at each end of the unit where the third metal layer has not been removed). This selective removal may be performed by any suitable process, including, for example, standard photo-resist and etching techniques. Similarly, the upper plating layer 82 and the fourth metal layer 50 are masked and selectively etched away to form upper isolation areas 99 on the upper surface of the sheet that are devoid of metal and that divide the fourth metal layer 50 and the upper plating layer 82 of each unit 24 into separate first and second upper terminal pads 94, 96.

The two lower terminal pads 90, 92 are suitably positioned in regions adjacent the opposite ends of the device or unit 24, and they are respectively connected to the corresponding upper terminal pads 94, 96 by the respective insulated conductive channels that respectively form the external interconnections 66, 68. Furthermore, the first metal layer 12 is electrically connected to the fist lower terminal pad 90 by the lower internal interconnection 84, while second metal layer 14 is electrically connected to the second upper terminal pad by the upper internal interconnection 86. Thus, a first terminal is formed, comprising the first lower terminal pad 90, the first external interconnection 66, and the first upper terminal pad 94, which terminal provides electrical connection to the first metal layer 12, which thereby forms a first electrode. Likewise, a second terminal is formed, comprising the second lower terminal pad 92, the second external interconnection 68, and the second upper terminal pad 96, which terminal provides electrical connection to the second metal layer 14, which thereby forms a second electrode. This results in a symmetrical PTC device 24 which, when singulated from the sheet 10 (i.e., the overall matrix of devices), may used directly as an SMT PTC device. Suitable techniques for singulation are well known in the art and include routing, guillotining, dicing, punching, laser cutting and scouring.

In particular, the process described above produces a matrix comprising a plurality of laminar PTC devices which may be singulated from the original matrix. Each of the PTC devices comprises a first or lower electrode 12 formed from the first metal layer 12, and a second or upper electrode 14 formed from the second metal layer 14. A layer of PTC material 16 is sandwiched between these first and second electrodes 12, 14. The first electrode 12 is substantially covered by a first layer 40 of insulating material. Similarly, the second electrode 14 is substantially covered by a second layer of insulating material 42. A third metal layer 48 is provided on the first insulating layer 40. The third metal layer 48 is divided to form first and second lower terminal pads 90, 92 on the underside of the device. The two lower terminal pads are positioned in regions adjoining opposing ends of the PTC device. The first lower terminal pad 90 is connected to the first electrode 12 by the first internal interconnection 84 that passes through the first layer of insulating material 40. The second lower terminal pad 92 is separated from the first lower terminal pad 90 by the lower isolation area 97 where the third metal layer 48 has been selectively removed, and it is insulated from the first electrode 12 by the first layer of insulating material 40.

Likewise, the fourth metal layer 50 is divided by the upper isolation area 99, where metal has been selectively removed, to provide the first and second upper terminal pads 94, 96. The first and second upper terminal pads 94, 96 are positioned in regions adjoining opposing ends of the PTC devices. Suitably, the positioning of the first and second upper terminal pads 94, 96 corresponds directly to positioning of the first and second lower terminals 90, 92, respectively. In other words, the first upper terminal pad 94 is formed on the opposing side of the PTC device to the first lower terminal pad 90, and the second upper terminal pad 96 is formed on the opposing side of the PTC device to the second lower terminal pad 92.

The second upper terminal pad 96 is connected to the second electrode 14 by the second or upper internal interconnection 86 that passes through the second layer of insulating material 42. The first upper terminal pad 94 is separated from the second upper terminal pad 96 by the upper isolation area 99 where metal has been selectively removed, and it is insulated from the second electrode 14 by the second layer of insulating material 42.

The first lower terminal pad 90 is electrically connected to the first upper terminal pad 94 by the first conductive external interconnection 66, which passes through and is insulated from the first and second electrodes 12, 14 and the layer of PTC material 16. Similarly, the second lower terminal pad 92 is connected to the second upper terminal pad 96 by the second conductive external interconnection 68, which passes through and is insulated from the first and second electrodes 12, 14 and the layer of PTC material 16. It will be appreciated that the resulting PTC device comprises two paired arrangements of terminal pads on opposing sides of the PTC device. The effective resistance between the terminal pads in each pair is that of the PTC material (as contact and interconnect resistances are small in comparison, particularly when the PTC material is in a tripped state).

By using insulated conductive channels to provide the external interconnections 66, 68 from one side of the PTC device to the other, the effective surface area of the PTC material utilized by the device may be maximized.

The above described process results in a symmetrical PTC device that facilitates easy placement without the need for correct orientation of the device beforehand.

Of particular advantage is that the PTC devices are manufactured using techniques that are commonplace in the reasonably low cost manufacturing environment of the PCB industry. The above described process has been described with reference to the production of a symmetrical PTC device having a single layer of PTC material. It will be appreciated that further embodiments are possible. For example, a non-symmetrical device, i.e. where the device will only function correctly when placed with the underside down, may be provided by the omission of a number of the steps in the above described process and correspondingly the omission of a number of the features in the above described PTC device. In particular, the requirement for a second external interconnection provided by an insulated channel, a fourth metal layer and a second layer of insulating material may be obviated as illustrated in the exemplary structure of FIG. 10. In particular, a non-symmetrical laminar PTC device may be provided, comprising a first laminar metal electrode 12 and a second laminar metal electrode 14. A layer of PTC material 16 is sandwiched between these first and second electrodes 12, 14. The first electrode 12 is substantially covered by a first layer of insulating material 40. A third layer of metal 48 is provided on the first layer of insulating material 40. The over-plated third layer of metal 48 is divided by an isolation area 97 to form first and second lower terminal pads 90, 92. The two terminal pads are positioned in regions adjoining opposing ends of the PTC device. The first terminal pad 90 is connected to the first electrode 12 by an internal conductive interconnection 84 formed through an opening or micro-via that passes through the first layer of insulating material 40. The second terminal pad 92 is separated from the first terminal pad 90 by the isolation area 97 where the over-plated third metal layer 48 has been selectively removed, and it is insulated from the first electrode 12 by the first layer of insulating material 40.

The second terminal pad 92 is electrically connected to the second electrode 14 by a conductive channel that forms an external interconnection 68, formed as described above (with modifications to account for the absence of the second insulating layer and fourth metal layers), which passes through and is insulated from the first and second electrodes 12, 14 and the layer of PTC material 16.

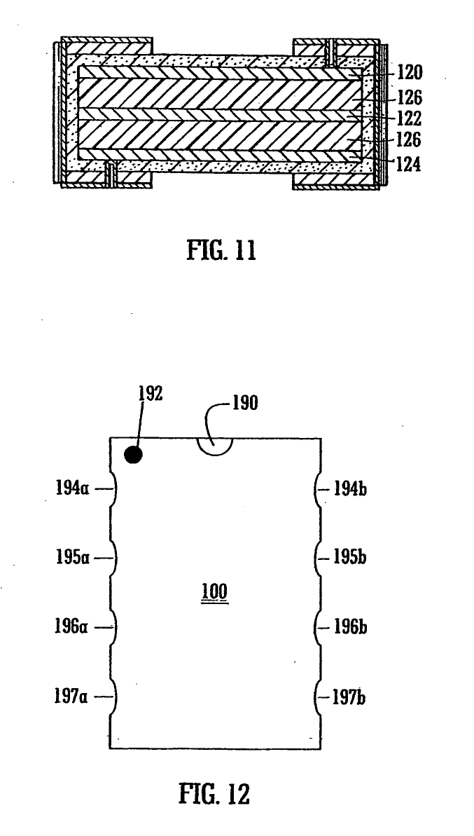

A further exemplary embodiment, as illustrated in FIG. 11, employs multiple layers of PTC material in the production of the PTC device instead of a single layer of PTC material. In this device, the single layer of PTC material sandwiched between two layers of metal (electrodes) is replaced by a laminar structure comprising three electrodes 120, 122, 124 interleaved with two layers of PTC material 126, 128. The remaining features and the method of manufacture are substantially unchanged.

This further embodiment in effect provides two PTC devices in series, with the middle electrode acting as a common electrode to the first device, comprising the top electrode and top layer of PTC material, and the second device comprising the bottom electrode and bottom layer of PTC material. It is believed that this multilayer structure provides a series combined PTC device having a higher breakdown voltage than would be achievable with a single PTC device.

An exemplary multi device package configuration is illustrated in FIG. 12, comprising a plurality of devices, of the type illustrated in FIGS. 9, 10 or 11, which may be fabricated in a matrix using the processes described above. The exemplary package 100 shown comprises four individual devices, although the exact number of devices can be altered depending on circumstances. Each of the individual PTC devices in the package 100 has pairs of terminals provided on the underside of the package 100 adjacent to the insulated plated channels 194a, 194b; 195a, 195b; 196a, 196b, 197a, 197b to which electrical connections may be made. The package 100 may readily be structured or configured to resemble an integrated circuit structure for subsequent use by pick and place machines. Apart from appropriately dimensioning the package 100 and positioning the plated channels to represent appropriate IC sizing and connections, additional features may be included during the manufacturing process. For example, a notch 190 may be provided in the top center of the package 100 to identify the position of the top of the device. Similarly, a small dot 192 may be provided in the top left hand corner of the package to identify the top left hand corner of the resulting device. These additional features may be provided using conventional PCB techniques including etching as integral steps within the manufacture of the matrix described above before singulation.

The resulting IC type device may be readily modified for use as a dual in-line package (DIP) by appropriate fixing of a lead frame.

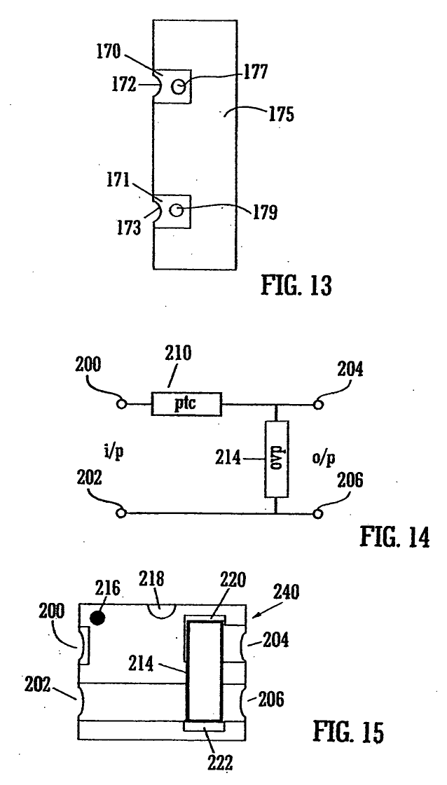

Although DIP packages are popular, in circumstances where board space is at a premium, single in-line packages (SIP) are preferred. The present invention may be readily adapted for use as a SIP package by providing paired terminals for connecting to each PTC device along one side of the package rather than on opposing sides of the device, for example as shown in the embodiment of FIG. 13. In particular, as shown, a SIP package 175 has two terminals 170, 171, with each terminal connecting to a laminar electrode of a PTC device encapsulated within the device. The two terminals 170, 171 are arranged along the same device edge. Plated through-hole external interconnections 172, 173 (formed prior to singulation from a matrix structure described above) provide electrical connections between the top and bottom surfaces of the terminals. As described previously, the through-hole interconnections 172, 173 are in effect insulated conductive channels that provide external interconnections that pass through the PTC material. One of the terminals 170 connects with a first laminar-electrode by-means of a first blind micro-via 177 (as previously described) on the top surface of the device, whereas the other terminal 171 connects with the second laminar electrode by means of a second blind micro-via 179 (shown in dashed outline) on the bottom surface of the device. The component may be used as a leaded device by attachment of a lead frame along the edge with the terminals. In either case, the component is not limited to single devices, and it will be appreciated that a SIP component may be manufactured having a plurality of devices, with each device having two terminals disposed along an edge of the component. Moreover, it will be appreciated that the exact number of PTC devices for a particular component is decided by the number of PTC devices grouped together as a single component during singulation of the matrix described above. However, to prevent cross effects between adjoining devices, separation of the electrodes in the first and second metal layers is required.

Depending on the application, the individual characteristics of the devices may be equivalent or different. Different characteristics may be achieved by having differently sized electrodes, which may be effected at the previously described stage of defining singulation references.

As the PTC devices described herein are manufactured using conventional PCB techniques, the resulting devices may be used as miniature printed circuit boards onto which further circuit protection devices, for example a battery charge controller or an over-voltage protection device, such as a gas discharge tube, a thyristor or a metal oxide varistor (MOV) may be fixed, for example by direct soldering to the terminals, to provide a circuit protection module. An exemplary input protection circuit is shown in FIG. 14, comprising a PTC device 210 providing over-current protection, in series with an incoming line 200 followed by an over-voltage protection device 214, for example a thyristor, MOV, or gas discharge tube (GDT), in parallel with the outputs 204. The circuit of FIG. 14 may be manufactured by singulating a device from the previously described matrix to provide a PTC device having an input terminal 200 on one side of the device and an output terminal 204 on the opposing side of the device. A track may also be provided in the same process used to define the terminals to provide a direct electrical connection between the second input line 202 and the output 206.

The circuit of FIG. 14 may be packaged as a component 240 of the type illustrated in FIG. 15. The top surface of the component 240 is suitably configured, as shown in FIG. 15, such that the output terminals on the top surface of the device are configured as terminal-pads 220, 222 to which the voltage protection device 214 is electrically connected. The voltage protection device 214 may be fixed to the pads 220, 224 by means such as pre-placed solder paste (which may be then reflowed) or a conductive epoxy. The resulting component 240 may be used as an SMT line protection device, with the terminals underlying the device (or plated channels\notches at the sides) providing SMT connection points. Additionally, as described above, suitable device markings may be included to aid orientation of the device. For example, a notch 218 may be provided in the top center of the component 240 to identify the top of the component. Similarly, a small dot 216 may be provided in a pre-selected corner of the component 240 for orientation purposes.

A drawback of existing PTC devices is that the effective area of the PTC material limits the trip currents of the devices. However, as circuit board space is generally at a premium, designers are reluctant to use devices having large device footprints. One solution to this problem is to provide PTC devices in a parallel configuration using a multilayer device construction. There has been a constant effort in the art to reduce the costs and to increase the efficiencies of manufacturing such multilayer devices.

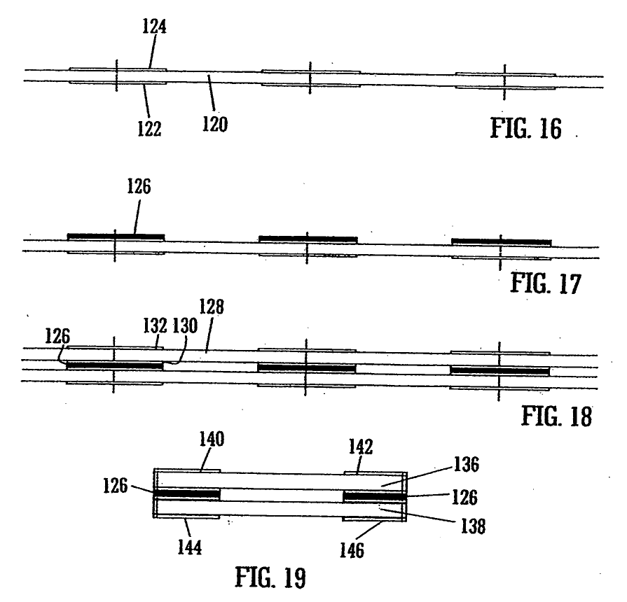

The matrix construction of the present invention facilitates a simple and efficient method of providing two or more devices in parallel in a quasi-multilayer construction. A side view of a section of a matrix of devices (of the symmetrical type shown in FIG. 9) is illustrated in FIG. 16. (The internal construction of the device is not shown for ease of explanation, with the vertical dashed lines representing points along which devices would be singulated equating to the locations of the insulated plated through-hole external interconnections of FIG. 9). Each of the individual devices of the matrix has four terminals defined to provide device symmetry when singulated. The method commences with the placing of a first matrix of devices 120 in a suitable jig or fixture (not shown). Solder paste 126 or other conductive fixing/adhesive material (e.g. conductive glue) is applied to the terminal areas 124 on the top surface of the matrix as shown in FIG. 17. A second matrix of devices 128 having a matching arrangement of terminals areas 130 on its underside is then placed on top of the first matrix as shown in FIG. 18. In the case of using solder paste, the entire arrangement is then placed in a reflow oven to cause the solder paste to flow. When cooled the, the two matrices are held together in a double-decked or duplicate matrix structure by the solder material, which electrically connects the terminals areas of the two matrices. It will be appreciated that when the resulting duplex matrix is singulated, the singulated devices, as shown in FIG. 19, are in effect two devices 136, 138 connected in parallel with the terminals 140, 142 on the upper surface of the top device providing one pair of terminals and the terminals on the lower surface of the bottom device providing a corresponding pair of terminals 144, 146 on the bottom surface. Each of the top terminals 140, 142 is electrically connected to its respective bottom terminal 144, 146 by respective insulated plated channels (as described previously and shown in dashed outline in FIG. 19) in cooperation with the terminals 124, 130 and solder material 126. This method of manufacturing devices in parallel is not limited to the use of two matrices, several matrices may be joined concurrently. However, as the number of matrices increases, practical difficulties arise in causing the solder paste to reflow correctly. This difficulty may be overcome if a conductive epoxy or other material is used in place of the solder paste.

Although the present invention has been described with reference primarily to an active material of the PTC type, it will be appreciated that the manufacturing process of the present invention may be advantageously applied to other active polymer materials and PTC materials and also to other materials including dielectrics, resistive, magnetic and semiconductor materials.

Although the present invention has been described with reference to commencement of manufacture from a laminated sheet of electronically active (e.g. PTC) material sandwiched between a first layer of metal and a second layer of metal, the method may commence with a layer of electronically active (e.g. PTC) material upon which metal foils may be placed, or metal layers deposited (e.g. by plating) as part of the manufacturing process described herein.

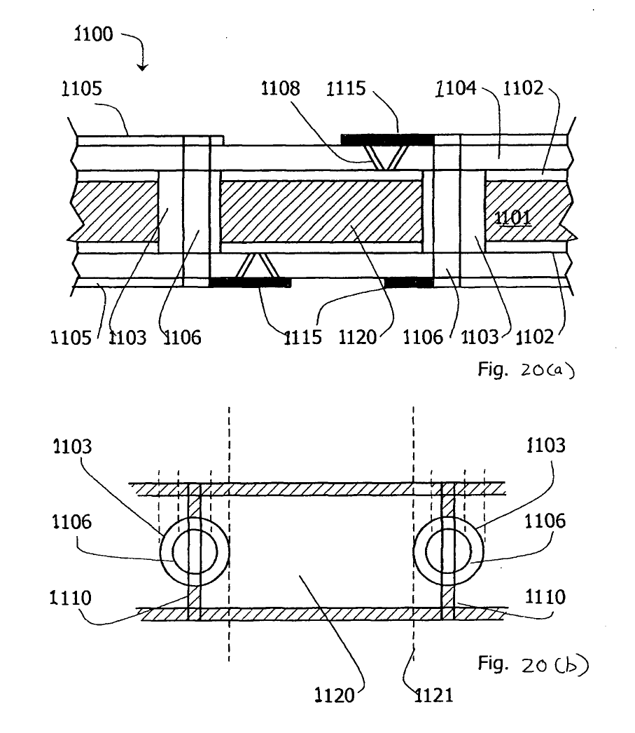

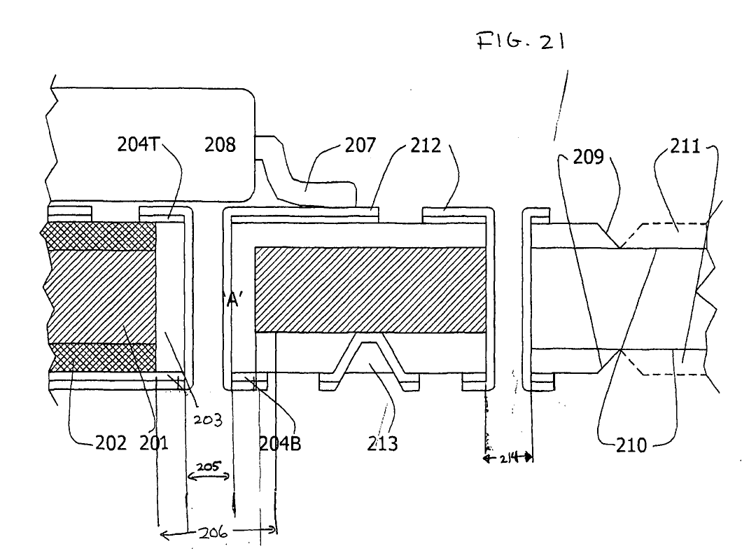

Referring to FIGS. 20(a) and 20(b) cross-sectional side views and plan views of a component 1100 are illustrated. A layer 1101 of component material is provided in a sheet of a size such as 300×600 mm. There is a layer 1102 of Cu foil on each side.

Through vias 1103 are drilled at spacings of the length of a component to be produced, a component's active material being bounded by each successive pair of vias 1103.

Sheets of prepreg 1104 and Cu foil 1105 are then applied on either side. All of the layers are then pressed so that the prepreg flows and fills the vias 1103 (which are no longer through vias). This filling of the vias 1103 isolates in the dimensions illustrated the portions of foil 1102 for the component.

A smaller-diameter micro via 1106 is then drilled through the filled prepreg of each previous via 1103. Each microvia 1106 is then plated, providing a conductive path between the outer foil layers 1105. The outer foil layers 1105 are then selectively etched, and sloped microvias 1108 are drilled between the outer and inner foil layers 1105 and 1102 on each side.

A component is then isolated by cutting (either optically or mechanically) along cut lines 1110. The cut vias 1103, 1106 then form side groove structures, each including an insulating groove structure and plated groove structure, in the isolated component.

Similar operations take place in the perpendicular direction so that a component is fully diced. This component has:

an active material 1120,

outer terminals 1115 formed by the remaining outer foil 1105, and

conductive interconnections top to bottom via the plating of the micro vias 1106.

It will thus be appreciated that the invention provides for production of a large number (e.g. 100,000) components from a single composite layer sheet. The drilling and filling steps provide for effective isolation of the inner foil, allowing it to be used as an inner pad. The microvias 1106 drilled at the same locations provide the necessary top to bottom interconnections, as well as cutting fiducials for dicing of the components. Also, the end-product component has a large effective area, indicated by the lines 1121 in the dimensions illustrated.

The advantages arising from handling sheets of material instead of discrete components bodies will be immediately apparent to those skilled in the art. For example, handling of a single 300×600 mm composite layer sheet can lead to approximately 100,000 components.

The components may be subsequently encapsulated, if required, although this introduces an element of handling discrete components.

A still further advantage is that the various vias and exposed plating provide excellent thermal cooling.

These method steps can be used in various combinations for different applications, such as the following applications A, B and C.
(A) Produce feed through connections through a conductive material/device in sheet form, or
(B) to producing two terminal (rectangular) devices with terminals on same sides from a sheet of component material with terminals on opposite sides, or
(C) to incorporation of at least one thick thermal conductor inside a printed circuit board/printed wire board.

(A) is accomplished through:
(1) Drilling holes 1103 through the primary “sheet material” 1101/1102 (“SM” hereinafter). The active material 1101 may be a homogenous conductive/active/resistive/capacitive material or a semiconductor or a semi fabricated printed circuit board with plated through holes. Hereinafter the sheet is regarded to extend in x and y, its thickness extending in z.
(2) Pressing in a vacuum multilayer press the SM with prepreg 1104 between it and copper foil 1105 on outer sides, causing resin material from the prepreg to flow and fill and cure in all drilled holes 1103.
(3) Drilling new smaller holes 1106 completely inside the holes drilled in (1) above; that is through the resin material cured in (2), small enough to be completely insulated from the SM.
(4) Plating the drilled surface area of these holes to connect with copper foils 1105 on outer layers and then etching the outside copper foils to provide required conductors 1115, as producing a standard printed circuit board with conductor patterns and plated through holes. The insulated plated feed through holes inside holes drilled in (1), filled in (2) and plated in (3) are herein after called “via in fill”, VIF.
(5) Optionally repeating the stages (2) to (4) above inside the VIF produced to at least once produce another VIF inside.

(B) above is accomplished by adding connections from required top and bottom copper foil areas 1105 to adjacent copper foils 1102 on the SM by means of micro vias 1108 (blind vias) during the stages of (A) above. Then one may cut the sheet completed in (A) above into individual packaged components with cuts in (middle) between VIF holes 1106 in one direction (i.e. X) and cuts through (middle) VIF holes in the other (i.e. Y) direction. The latter cuts will expose parts of VIF holes on two adjacent sides of the components and provide increased connection surface area for soldering, and provide two external electrodes each connected to one of the SM's primary electrodes on both top and bottom sides, configured through standard PCB design methods realized during stage (A) above.

The cladded substrate can be etched in sheet form before drilling to provide any pattern required for whatever purpose, including specifically terminating metal foil lands inside later cut edges of parts to avoid exposed metal and avoiding cutting through metal when forming single units.

(C) Above is accomplished by using a copper or aluminum plate to other material with suitable weight and heat transfer properties as the SM through the stages of (A) above. By incorporating a release film at one or more edge(s) or in suitable areas on one or two sides of the SM during pressing stage above, such areas of the SM can after final machining be easily exposed for fastening to external cooling assembly. When the SM is made of materials compatible with chemical processes employed during stages in (A) above, suitable connections to the circuitry can be made through the SM by drilling in none pre drilled places and plate connections as normal during stages in (A) above. Holes can be made by mechanical or chemical methods. Holes may be of any shape.

Advantages of (C):

The incorporation of combined power planes/heatsinks of more substantial thickness than normally can be bought prebonded as a laminate (70 up to 210 micron special order), inside a printed circuit board is made possible with standard engineering materials prepared with standard methods. The enhanced cooling will enable a multitude of devices to be attached to such low profile heatsink(s) inside a PCB instead of employing heatsinks on each component. By using thin lamination materials (prepreg) with high resin content on a SM of aluminium for instance making up the main thickness of the finished product, cost can be reduced without resorting to special expensive copper clad aluminium laminates, usually single sided.

Referring to FIG. 21, holes 214 and 206 are initially drilled through a substrate. Release film 210 to prevent adhesion of prepreg to the substrate is shown in one place. Sheets of prepreg 202 are placed on either side of this. During lamination, resin from prepreg 204 flows to fill holes 206 and 214. Then holes of type 205 are drilled out with smaller diameter 205 hole. Holes for micro vias 213 are then formed. The resulting resin or insulating structure 203 is shown. Copper 212 is then plated to connect 204B area with 204T area, providing an isolated connection through substrate 201. A standard via connecting top foil area and bottom foil area can then also be formed, when substrate is compatible with plating solutions used. Scoring lines 209 are shown to separate cured laminate 211—part of 202 initially, from an edge of finished board to expose substrate for attachment to external heat transfer equipment. The release film 210 makes this feasible.

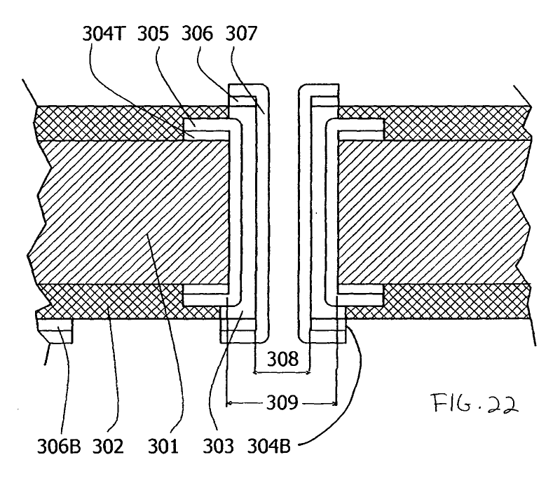

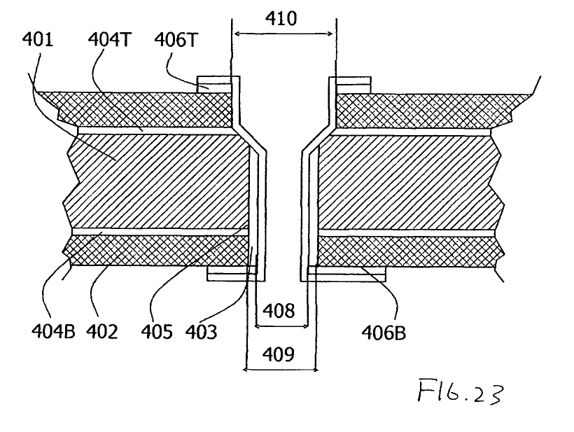

FIG. 22 shows a substrate with copper foil embedded in similar fashion to provide a via inside another (buried through the process) via. The initial via can in FIG. 22 be a via in a standard double sided semi fabricated PCB, or a multilayer or other substrate. In FIG. 22, a substrate 301 may be sandwiched between prepreg layers 302. A first via 309 and a corresponding second via 308 are shown. A resin or insulating structure 303 lines the wall of the first via 309. Various conductive layers 304B, 304T, 305, 306, and 307 are also shown.

FIG. 23 is showing how a connection can be made between foils 406T, and 404T and 406B, without connecting to foil 404B. It is possible to drill a hole 409 prior to lamination, and then drill hole 408 through and 410 partly through the structure after lamination. As in other examples, a component layer 401 may be between prepreg layers 402.

In general, the substrate or component layer may be of a material that suits one or several specific purposes, as for instance lead to protect from radiation, magnetic materials for purpose of reinforcing magnetic fields for coils, or diamagnetic materials for containment or expulsion of magnetic fields from a specific area and hereby concentrating magnetic fields in an adjacent area or special high heat transfer materials of low density.

The substrate need not be a single sheet throughout a produced PCB or panel. Sometimes it is convenient to produce in one sheet that hold together with “pips” during assembly for lamination pressing, that later can be cut or isolated by drilling off these. Different substrates can also be combined in one PCB. Embedded components can be located between sheets for specific purpose(s) as per above.

The invention is not limited to the embodiments described but may be varied in construction and detail. For example, the dicing step may be omitted, providing a large integrated number of embedded components.

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed.

1. A method of manufacturing an electronic device from a structure comprising at least one layer of device material sandwiched between a first layer of metal and a second layer of metal, comprising the steps of:
forming a first aperture through the first layer of metal, the second layer of metal and the device material,
applying a first layer of insulating material to the first metal layer,
insulating the walls of the first aperture,
providing a third metal layer on the first layer of insulating material,
forming a second aperture within the region defined by the first aperture,
providing a first electrical interconnection between the top and bottom surfaces of the through the second aperture,
creating an electrical interconnection between the third metal layer and the first metal layer, selectively removing metal from the third metal layer to define first and second electrode areas, wherein the first terminal includes the electrical interconnection created between the third metal layer and the first metal layer and the second terminal includes the plated second aperture.

2. A method of manufacturing a device according to claim 1, wherein said step of insulating the walls of the first aperture is performed at least in part by the step of applying the first layer of insulating material to the first metal layer.

3. A method of manufacturing a device according to claim 1, comprising the further steps of:
applying a second layer of insulating material on the second metal layer, and
providing a fourth metal layer on the second layer of insulating material in advance of forming the second aperture.

4. A method of manufacturing a device according to claim 3, wherein said step of insulating the walls of the first aperture is performed at least in part by the step of applying the second layer of insulating material to the first metal layer.

5. A method of manufacturing a device according to claim 4, comprising the further steps of: forming a third aperture, in advance of the application of the insulating layers, through the first metal layer, second metal layer and the at least one layer of device material, forming a fourth aperture within the region defined by the third aperture, and plating the fourth aperture to provide a second electrical interconnection between the top and bottom surfaces of the device.

6. A method of manufacturing a device according to claim 5, comprising the additional step of selectively removing material from the fourth metal layer to define third and fourth terminals.

7. A method of manufacturing a device according to claim 1, wherein the first and third apertures are formed at opposing ends of the device.

8. (canceled)

9. A method of manufacturing a device according to claim 1, wherein the steps of applying a first layer of insulating material to the first metal layer and providing a third metal layer on the first layer of insulating material are performed in a single step by the application of a resin clad metal.

10. A method of manufacturing a device according to claim 9, wherein said resin clad metal is copper.

11. A method of manufacturing a device according to claim 5, wherein the steps of applying a second layer of insulating material to the second metal layer and providing a fourth metal layer on the second layer of insulating material are performed in a single step by the application of a resin clad metal.

12. A method of manufacturing a device according to claim 11, wherein said resin clad metal is copper.

13. A method of manufacturing a device according to claim 12, wherein said structure comprising at least one layer of device material sandwiched between a first layer of metal and a second layer of metal is a multi layer structure comprising alternating layers of device material and metal.

14. A method of manufacturing a device according to claim 1, wherein the device is a PTC device and the device material is a PTC material.

15. A method of manufacturing a device according to claim 1, wherein said structure comprising at least one layer of device material sandwiched between a first layer of metal and a second layer of metal is provided as a laminated sheet.

16. An electronic device comprising:
a first metal layer,
a second metal layer,
at least one layer of device material sandwiched between the first metal layer and the second metal layer which function as electrodes for the device material,
a first terminal for providing a first electrical connection to the device,
a second terminal for providing a second electrical connection to the device,
wherein the first terminal is electrically connected to the first metal layer and the second terminal is insulated from the first metal layer and electrically connected to the second metal layer by a conductive channel which passes through and is insulated from the first metal layer and device material.

17. A device according to claim 16, wherein the conductive channel comprises a metal plated channel.

18. A device according to claim 16, wherein the second terminal is insulated from the first metal layer by a first layer of insulating material.

19. A device according to claim 18, wherein said first layer of insulating material substantially covers said first layer of metal.

20. A device according to claim 18, comprising a third layer of metal disposed on the first layer of insulating material and where said third layer is divided by an isolation area to provide the first terminal and the second terminal.

21. A device according to claims 16, further comprising
a third terminal for providing a third electrical connection to the device,
a fourth terminal for providing a fourth electrical connection to the device,
wherein the fourth terminal is electrically connected to the second metal layer and the third terminal is insulated from the second metal layer and electrically connected to the first metal layer by a second conductive channel which passes through and is insulated from the second metal layer and device material.

22. A device according to claim 21, wherein the second conductive channel comprises a metal plated channel.

23. A device according to claim 21, wherein the second terminal is insulated from the second metal layer by a second layer of insulating material.

24. A device according to claim 23, wherein said second layer of insulating material substantially covers said second layer of metal.

25. A device according to claim 24, wherein the fourth terminal is electrically connected to the second metal layer by an interconnect formed through said second layer of insulating material.

26. A device according to claim 21, wherein the second conductive channel is provided at one end of the device.

27. The device of claim 26, wherein the first conductive channel and second conductive channel are located at opposing ends of the device.

28. The device of claim 16, wherein the first conductive channel is located at one end of the device.

29. A device according to claim 16, wherein said terminals are plated.

30. A device according to claim 29, wherein said terminals are plated with nickel, copper and/or gold.

31. A device according claim 16, wherein said insulating material comprises a cured resin.

32. A device according to claim 16, wherein said at least one layer of device material comprises alternating layers of device material and metal.

33. A device according to claims 16, wherein said device is a PTC device and said device material is a PTC material.

34. A PTC device comprising:
a first metal layer,
a second metal layer,
at least one layer of PTC material sandwiched between the first metal layer and the second metal layer,
a first terminal for providing a first electrical connection to the device,
a second terminal for providing a second electrical connection to the device,
wherein the first terminal is electrically connected to the first metal layer and the second terminal is electrically connected to the second metal layer by a conductive channel which passes through and is insulated from the first metal layer and the at least one layer of PTC material.

35. A method of manufacturing a matrix of electronic devices from a structure comprising at least one layer of device material sandwiched between a first layer of metal and a second layer of metal, comprising the steps of:
forming a first array of apertures through the first layer of metal, the second layer of metal and the device material,
applying a first layer of insulating material to the first metal layer,
insulating the walls of the first array of apertures,
providing a third metal layer on the first layer of insulating material,.
forming a second array of apertures such that each aperture of the second array is positioned within the region defined by an aperture from the first array of apertures, providing electrical interconnections between the top and bottom surfaces of the matrix through the second array of apertures to create electrical interconnections between the third metal layer and the first metal layer,
selectively removing metal from the third metal layer to define first and second terminals for each device of the matrix, wherein each first terminal includes an electrical interconnection between the third metal layer and the first metal layer and each second terminal includes an insulated electrical interconnection between the top and bottom surfaces of the device.

36. A method of manufacturing a matrix of electronic devices according to claim 35, wherein said step of insulating the walls of the first array of apertures is performed at least in part by the step of applying the first layer of insulating material to the first metal layer.

37. A method of manufacturing a matrix of electronic devices according to claim 35, comprising the further steps of:
applying a second layer of insulating material on the second metal layer, and providing a fourth metal layer on the second layer of insulating material in advance of forming the second array of apertures.

38. A method of manufacturing a matrix of electronic devices according to claim 37, wherein said step of insulating the walls of the first array of apertures is performed at least in part by the step of applying the second layer of insulating material to the first metal layer.

39. A method of manufacturing a matrix of electronic devices according to claim 38, comprising the further steps of:
forming a third array of apertures, in advance of the application of the insulating layers, through the first metal layer, second metal layer and the at least one layer of device material,
forming a fourth array of apertures within the region defined by the third array of apertures, and
providing electrical interconnections between the top and bottom surfaces of the device through the fourth array of apertures.

40. A method of manufacturing a matrix of electronic devices according to claim 39, comprising the additional step of selectively removing material from the fourth metal layer to define third and fourth terminals for individual devices in the matrix.

41. A method of manufacturing a matrix of electronic devices according to claim 35, wherein each of the first array of apertures and each corresponding aperture of the third array of apertures are formed on opposing ends of the individual devices within the matrix.

42. (canceled)

43. A method of manufacturing a matrix of electronic devices according to claim 35, wherein the steps of applying a first layer of insulating material to the first metal layer and providing a third metal layer on the first layer of insulating material are performed in a single step by the application of a resin clad metal.

44. A method of manufacturing a matrix of electronic devices according to claim 43, wherein the metal of said resin clad metal is copper.

45. A method of manufacturing a matrix of electronic devices according to claim 40, wherein the steps of applying a second layer of insulating material to the second metal layer and providing a fourth metal layer on the second layer of insulating material are performed in a single step by the application of a resin clad metal.

46. A method of manufacturing a matrix of electronic devices according to claim 45, wherein the metal of said resin clad metal is copper.

47. A method of manufacturing a matrix of electronic devices according to claim 35, wherein said structure comprising at least one layer of device material sandwiched between a first layer of metal and a second layer of metal is a multi layer structure comprising alternating layers of device material and layers of metal.

48. A method of manufacturing a matrix of electronic devices according to claim 35, wherein the device is a PTC device and the device material is a PTC material.

49. (canceled)

50. A method of manufacturing a matrix of electronic devices according to claim 35 comprising the further step of singulation of devices.

51.-53. (canceled)

54. A method of manufacturing a matrix of electronic devices according to claim 50, wherein the device material is a dielectric material.

55. A matrix of electronic devices comprising:
a first metal layer,
a second metal layer,
at least one layer of device material sandwiched between the first metal layer and the second metal layer which function as electrodes for the device material,
a first array of terminals for providing electrical connections to individual devices of the matrix,
a second array of terminals for providing electrical connections to individual devices of the matrix,
wherein the first array of terminals are electrically connected to the first metal layer and the second array of terminals are insulated from the first metal layer and electrically connected to the second metal layer by conductive channels which pass through and are insulated from the first metal layer and device material.

56. A matrix of electronic devices according to claim 55, wherein the conductive channels comprise metal plated channels.

57. A matrix of electronic devices according to claim 55, wherein the second array of terminals are insulated from the first metal layer by a first layer of insulating material.

58. A matrix of electronic devices according to claim 57, wherein said first layer of insulating material substantially covers said first layer of metal.

59. A matrix of electronic devices according to claim 57, comprising a third layer of metal disposed on the first layer of insulating material and where said third layer is divided to provide the first array of terminals and the second array of terminals.

60. A matrix of electronic devices according to claim 55, further comprising
a third array of terminals for providing electrical connections to the individual devices,
a fourth array of terminals for providing electrical connections to the individual devices, wherein the fourth array of terminals are electrically connected to the second metal layer, and the third array of terminals are insulated from the second metal layer and electrically connected to the first metal layer by a second array of conductive channels which pass through and are insulated from the second metal layer and material.

61. A matrix of electronic devices according to claim 60, wherein the second array of conductive channels comprises metal plated channels.

62. A matrix of electronic devices according to claim 60, wherein the second array of terminals are insulated from the second metal layer by a second layer of insulating material.

63. A matrix of electronic devices according to claim 60, wherein said second layer of insulating material substantially covers said second layer of metal.

64. A matrix of electronic devices according to claim 63, wherein the fourth array of terminals are electrically connected to the second metal layer by interconnects formed from through said second layer of insulating material.

65. A matrix of electronic devices according to claim 60, wherein each of the array of second conductive channels is provided at an end of each device of the matrix.

66. A matrix of electronic devices according to claim 65, wherein each of the array of first conductive channels and second conductive channels are provided on opposing ends of each device of the matrix.

67. A matrix of electronic devices according to claim 65, wherein the terminals are plated.

68. A matrix of electronic devices according to claim 65, wherein the terminals are plated with nickel, copper and/or gold.

69. A matrix of electronic devices according to claim 55, wherein said insulating material comprises a cured resin.

70. A matrix of electronic devices according to claim 55, wherein said at least one layer of device material comprises alternating layers of device material and layers of metal.

71. A matrix of electronic devices according to claim 60, wherein said device is a PTC device and said device material is a PTC material.

72. (canceled)

73. A method of producing a component comprising the steps of:
providing a cladded component layer including a component layer and a conductive layer on at least one side of the component layer;
drilling through the conductive and component layers to provide a first via; and
filling the first via with an insulating material.

74. A method as claimed in claim 73, further comprising:
dicing the cladded component layer by cutting through the first via to provide discrete components.

75. A method as claimed in claim 73, wherein the conductive layer is an inner conductive layer and wherein the method further comprises:
applying outer insulating and conductive layers to the cladded component layer;
drilling a second via in a location of the filled first via; and
plating the second via to interconnect the outer conductive layers.

76. A method as claimed in claim 75, further comprising:
etching the outer layers to define outer terminals, at least some of which are connected to the second via plating.

77. A method as claimed in claim 76, wherein the outer and inner conductive layers are interconnected by microvias on at least one side of the component layer.

78. A product made by the process of claim 77.

79. An electrical component comprising:
a component layer;
inner conductive layers on opposite sides of the component layer; and
a groove structure including an insulating groove structure and a plated groove structure formed at an edge of the component wherein, the plated groove structure electrically couples the inner conductive layers.

80. The electrical component of claim 79 further comprising outer insulating layers and outer conductive layers on the inner conductive layers.

81. The electrical component of claim 80 further comprising plated microvias respectively coupling inner conductive layers to the outer conductive layers.
